(19) United States
(12) Patent Application Publication
(10) Pub. No.: US 2004/0223640 A1
(43) Pub. Date: Nov. 11, 2004

(54) Stereo matching using segmentation of image columns

(76) Inventor: Alexander V. Bovyrin, N. Novgorod (RU)

Correspondence Address: Timothy N. Trop, TROP, PRUNER & HU, P.C., STE 100, 8554 KATY FWY, HOUSTON, TX, 77024-1841, US

(21) Appl. No.: 10/434,687

(22) Filed: May 9, 2003

(51) Int. Cl. G06K 9/00

(52) U.S. Cl. 382/154

(57) ABSTRACT

In one embodiment of the present invention, a method includes grouping pixels of columns of a first image of an image pair into column segments; and creating a disparity map for the image pair using the column segments.

### BACKGROUND

The present invention relates to generally to stereo vision technology and more specifically to stereo matching of image pairs.

Fast and robust estimation of three dimensional (3D) geometry made according to information from two images is very useful for many applications, such as computer vision systems (including for example, human-machine interfaces, robotic vision, object detection and tracking, scene reconstruction, video processing, automated visual surveillance, face recognition/3D reconstruction, and gesture recognition systems) and the like.

Among stereo matching techniques for analyzing outputs of stereo images, global optimization methods like dynamic programming (DP) solve the stereo correspondence problem in polynomial time. However, stereo matching by standard DP techniques suffers from inter-row disparity noise and difficulty in selecting the right cost for occluded pixels. Thus, there is a need for improved stereo correspondence of an image pair.

### BRIEF DESCRIPTION OF THE DRAWINGS

FIG. 1 is a flow diagram of a method in accordance with one embodiment of the present invention.

FIG. 2 is a plan view of a capture system for use in accordance with one embodiment of the present invention.

FIG. 3 is a graphical representation of a portion of an image having column segmentation in accordance with an embodiment of the present invention.

FIG. 4 is a three dimensional view of a minimizing path in accordance with one embodiment of the present invention.

FIG. 5 is a block diagram of a system in accordance with one embodiment of the present invention.

### DETAILED DESCRIPTION

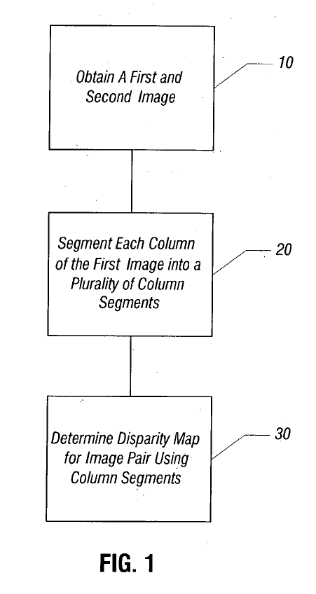

Referring now to FIG. 1, shown is a flow diagram of a method in accordance with one embodiment of the present invention. As shown in FIG. 1, a first and second image may be obtained (block 10). Such images may be two dimensional (2D) images of an object or scene for which estimation of 3D geometry thereof may be desired. While the images may be obtained from various sources, in certain embodiments the images may be obtained from video capture devices such as digital cameras, web cameras or the like.

As shown further in FIG. 1, each column of the first image may be segmented into a plurality of column segments (block 20). While the parameters for such segmentation may vary in different embodiments, in certain embodiments segmentation may be based on intensity and/or intensity gradient. In other words, pixels lying on the same column of an image may be grouped by intensity and/or intensity gradient.

Then, using these column segments, a disparity map may be determined for the image pair (block 30). In general, a disparity map may be obtained by measuring the difference between image blocks at the same position in the image pair. For example, if an image block appears in the first image at a different location than it appears in the second image, the disparity may be the measured difference between the two locations. An image block that appears in the second image ten pixels to the right of its location in the first image may be said to have a disparity ten pixels to the right. Generally, objects of shallow depth, i.e., closer to the foreground, exhibit more disparity than objects of greater depth, i.e., further from the foreground. By measuring the disparity associated with stereo images, a disparity map may be constructed. A disparity map thus provides three dimensional data from a pair of two dimensional images. In one embodiment, dense disparity maps may be used to reduce the inherent depth ambiguity present in two dimensional images and enable accurate segmentation under partial occlusions and self-occlusions.

In certain embodiments, a modified DP algorithm may be used to determine a disparity map. After decomposing image columns into segments, the disparity may be assumed to be the same for all pixels in the group. Thus in certain embodiments, a procedure similar to DP may be applied to the segmented image columns to estimate the disparity for all image rows simultaneously. In such manner, better quality depth maps may be produced with little inter-row disparity noise. In certain embodiments, such an algorithm may be used in real-time stereovision applications, as processing speeds of between approximately 15 and 25 frames per second may be achieved in typical environments.

After such processing, a disparity image may be formed. Using disparity information, it may be determined, for example, what objects lie in the foreground of a current scene. Moreover, using 3D information from the disparity map, objects in the scene may be more robustly recognized. Such recognition may be useful in robotic vision systems (e.g., to determine distance to objects and recognize them, to manipulate objects using robotic arms, for vehicle guidance, and the like).

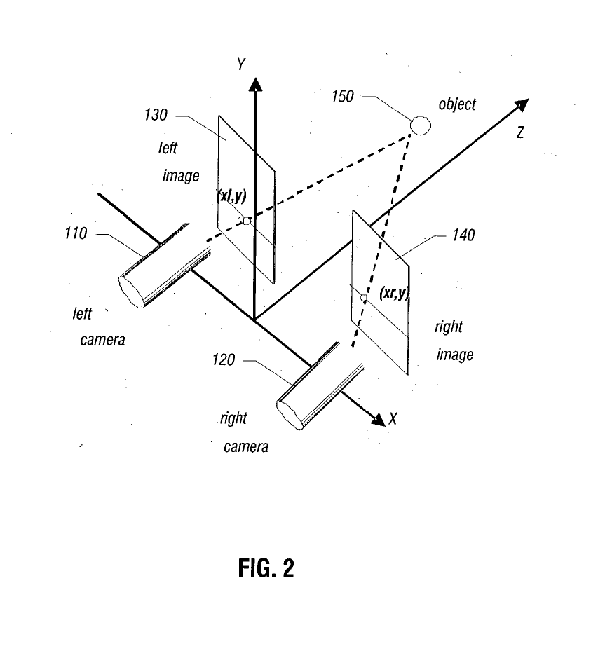

Referring now to FIG. 2, shown is a plan view of a capture system for use in accordance with one embodiment of the present invention. As shown in FIG. 2, the system includes a first camera 110 and a second camera 120. As shown in FIG. 2, cameras 110 and 120 may be parallel cameras. First camera 110 may be used to form a first (left) image 130 and second camera 120 may be used to form a second (right) image 140. While in the embodiment of FIG. 2, two cameras are used, in other embodiments a single stereo camera may be used to obtain an image pair.

As shown in FIG. 2, first and second images 130 and 140 may both include information regarding an object 150. The use of two or more images allows a three dimensional image to be obtained with a disparity map.

An algorithm in accordance with one embodiment of the present invention may use as inputs first image 130 and second image 140. If cameras from which the image pair is obtained are not parallel, a rectification process may be applied. Referring to FIG. 2, let point (x1,y1) on first (left) image 130 correspond to point (xr,yr) on second (right) image 140 (y1=yr=y, as the cameras are parallel in the embodiment shown in FIG. 2). The disparity in point (x1,y) is a value x1−xr. In one embodiment a disparity map D(x,y) may be produced for all pixels (x, y) on first image 130. The map D(x,y) may define a relative distance from first image 130 to object 150. For example if D(x1,y1)>D(x2,y2), then point (x1,y1) is closer than point (x2,y2) to object 150.

In various embodiments it may be desirable to segment each column of an image into groups of pixels based upon intensity and/or intensity gradient. Then each group may be assumed to have an equal disparity across the group, as disparity changes are non-uniform by intensity.

In different embodiments, various methods of segmenting columns may be used. For example, in an embodiment in which edges exist in an image, an edge detection mechanism may be used to segment the column. Thus if edges are present in first image 130 (e.g., from a Canny edge detector or other edge detection mechanism), it may be assumed with a certain probability that in the intervals of a column created between the edges, the disparity is a constant. In certain embodiments, other column segmentation may be achieved using a piecewise-linear approximation of the intensity on the image column. In this representation, the segments may define the column domains with the same gradient and the disparity may be assumed to be the same in the segment of the approximation. In one embodiment, a Douglas-Peucker approximation may be used to perform piecewise-linear approximation. In other embodiments, a whole image may be segmented by an appropriate algorithm, and then column segmentation may be performed on the image columns.

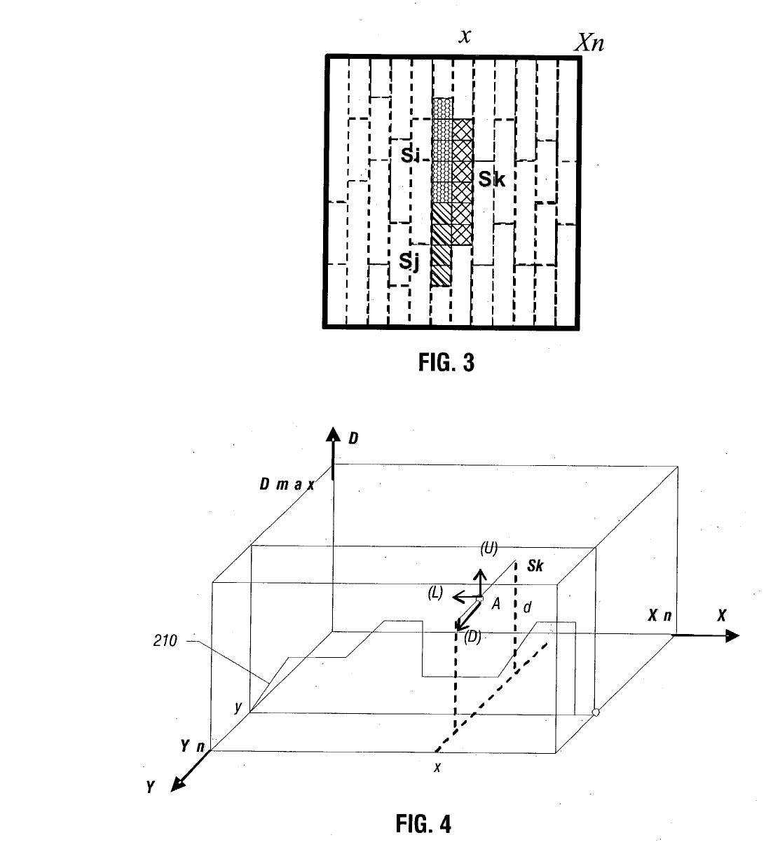

Referring now to FIG. 3, shown is a graphical representation of a portion of an image having column segmentation in accordance with an embodiment of the present invention. As shown in FIG. 3, each image column X may include a plurality of column segmentations. For example, column x-1 includes an Si and an Sj segment and column x includes an Sk segment, for example.

In various embodiments, for all image columns a certain segmentation SX={(S1, . . . ,Sn } may be determined, and the disparity on each segment Sk, k=1 . . . n may be assumed to not change.

Referring now to FIG. 4, shown is a three dimensional view of a minimizing path in accordance with one embodiment of the present invention. As shown in FIG. 4, Xn/Yn is the last pixel in a row/column, and Dmax is a maximum disparity value. Let the ordering constraint be valid, such that the relative ordering of pixels on an image row remains the same between the two views (this is a result of the assumption of the continuity of the 3D scene). This constraint allows use of an efficient stereo matching algorithm in accordance with an embodiment of the present invention.

In such an embodiment, a DP algorithm may be modified to process all image rows simultaneously to try to keep constant disparity in the column segments. In this embodiment, starting with the first column, on each segment Sk of column x (as shown in FIG. 4), the cumulative cost of the function for a disparity path may be minimized according to the following formula:

for ∀y ∈ Sₖ

$$C ( x , y , d ) = min \{ \begin{matrix}{\sum }_{j = Sk1}^{Sk2} [ C ( x - 1 , j , d ) + \vert {I}_{L} ( x , j ) - {I}_{R} ( x + d , j ) \vert ] , & left ( L ) \\ {\sum }_{j = Sk1}^{Sk2} [ C ( x - 1 , j , d - 1 ) + p ] , & diagonal ( D ) \\ {\sum }_{j = Sk1}^{Sk2} [ C ( x , j , d + 1 ) + p ] , & up ( U )\end{matrix} \} \qquad ( 1 )$$

where Sk1 is the beginning of Sk, Sk2 is the end of Sk, p is the local cost associated with a small disparity change, that is, the occlusion cost, I_{L}(x,y) is the intensity in the (x,y) point of the left image, and I_{R}(x+d,j) is the intensity in the (x,y) point of the right image. In other words, for each y the algorithm starts with C (0,y,0)=0 and minimizes (by d) C (Xn,y,0) using formula (1).

FIG. 4 shows an example of an optimal pass 210 in row y and three possible passes (L,D,U) for segment Sk. Note that the occluded points (i.e., points having a fixed cost p) are located in vertical and diagonal pieces of the optimal pass, and correspond to points that are only visible on the left and right image, respectively.

Using formula (1) for each d and Sk a local-optimal pass may be selected. To make this selection quickly, a property of segment connections may be used, in certain embodiments. Two segments Si and Sj (as shown in FIG. 3) are connected if they lie in adjacent rows and the following condition is satisfied: (si2≧Sj1)&(sj2≧Si1) Then formula (1) may be rewritten as:

$$C ( x , y , d ) = min \{ {\sum }_{j = 1}^{m} cos t ( Sj , d ) Len ( Sj , Sk ) + F ( Sk , d ) , {\sum }_{j = 1}^{m} cos t ( Sj , d - 1 ) Len ( Sj , Sk ) + p * Len ( Sk ) , cos t ( Sk , d + 1 ) Len ( Sk ) + p * Len ( Sk ) \} \qquad ( 2 )$$

where m is the number of the segments connected to Sk in the previous column, Sj is connected to the Sk segment (see FIG. 3), Len(Sk)=Sk2−Sk1+1, Len(Sj,Sk) is the number of the connected pixels between Sj and Sk (see FIG. 3). As shown in FIG. 3, segment Sk in column x is connected to two segments Si and Sj in column x-1, such that Len(Sk)=6, Len(Si,Sk)=4, and Len(Sj,Sk)=2. Further, cost(Sj,d) is the specific cost of Sj in the disparity d, and

$$cos t ( Si , d ) = {\sum }_{j = Si1}^{Si2} C ( x - 1 , j , d ) / Len ( Si ) , F ( Sk , d ) = {\sum }_{j = Sk1}^{Sk2} \vert {I}_{L} ( x , i ) - {I}_{R} ( x + d , i ) \vert .$$

Thus using formula (2), the local-optimal pass for all segments may be quickly calculated (i.e., for all (x,y,d)-points, as shown in FIG. 4) and the optimal pass for each y starting with (Xn,y,0) may be,restored to produce the disparity map D(x,y).

In various embodiments, the speed of the algorithm may depend on the number of column segments. By changing parameters of the approximation, the number of column segments may be significantly reduced. In certain embodiments, a user may change the algorithm speed by selecting a different intensity function approximation. In various embodiments, the algorithm may access memory sequentially during optimal pass searching, thus providing better cache utilization on modern processors, such as a PENTIUM™ 4 processor available from Intel Corporation, Santa Clara, Calif.

In certain embodiments, the most computationally expensive part of the algorithm may be the calculation of the F(Sk,d)function in formula (2) for each Sk and d because of the usage of the absdiff( ) function in each pixel. But using the following relation:

$${\sum }_{i = Sk1}^{Sk2} \vert {I}_{L} ( x , i ) - {I}_{R} ( x + d , i ) \vert \geq \vert {\sum }_{i = Sk1}^{Sk2} {I}_{L} ( x , i ) - {\sum }_{i = Sk1}^{Sk2} {I}_{R} ( x + d , i ) \vert = \overline{F} ( Sk , d ) \qquad ( 3 )$$

the (L) cost (in formula (1)) may be estimated using only one absdiff( ) per segment. If the (L) cost is not minimal (from (U) and (D) costs in formula (1)), this F(Sk,d) need not be calculated precisely.

In certain embodiments, a disparity map may be obtained via a fully automatic process by special parameter auto-tuning. The selection of the occlusion cost (parameter p in formulas (1) and (2)) is not trivial and a user typically tunes it manually. However, in certain embodiments p may be auto-selected. Starting with pmin and extending to pmax with a certain step pstep, an algorithm in accordance with an embodiment of the present invention may calculate a sum of disparity dispersions on all column segments by the following formula:

$${\sum }_{i = 1}^{N} \sqrt{Var ( {s}_{i} )} , Var ( {s}_{i} ) = {E ( d ( {s}_{i} ) )}^{2} - {( Ed ( {s}_{i} ) )}^{2} , Ed ( {s}_{i} ) = {\sum }_{x , y ∈ {s}_{i}} D ( x , y ) / Len ( {s}_{i} ) \qquad ( 4 )$$

After such calculation, the minimum may be selected as parameter p. While the time of this procedure depends on pmax—pmin and pstep, parameter p need not be estimated every time (for example, only in the first frames in a video stereo-sequence).

Example embodiments may be implemented in software for execution by a suitable data processing system configured with a suitable combination of hardware devices. For example, embodiments may be implemented in various programming languages, such as the C language or the C++ language. As such, these embodiments may be stored on a storage medium having stored thereon instructions which can be used to program a computer system or the like to perform the embodiments. The storage medium may include, but is not limited to, any type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) (e.g., dynamic RAMs, static RAMs, and the like), erasable programmable read-only memories (EPROMs), electrically erasable programmable read-only memories (EEPROMs), flash memories, magnetic or optical cards, or any type of media suitable for storing electronic instructions. Similarly, embodiments may be implemented as software modules executed by a programmable control device, such as a computer processor or a custom designed state machine.

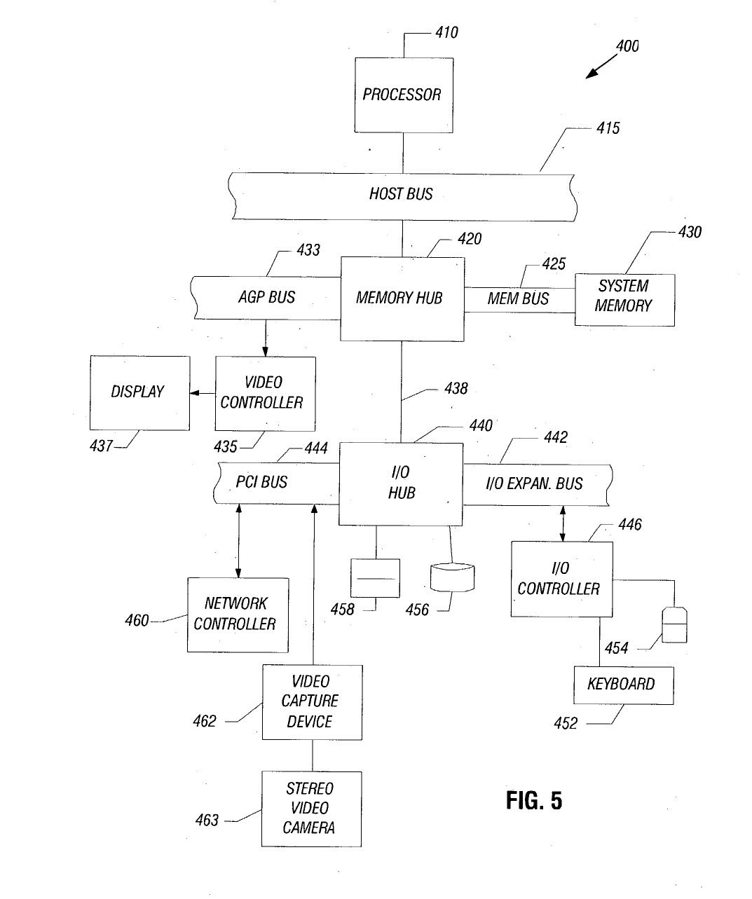

FIG. 5 is a block diagram of a representative data processing system, namely computer system 400 with which embodiments of the invention may be used.

Now referring to FIG. 5, in one embodiment, computer system 400 includes processor 410, which may include a general-purpose or special-purpose processor such as a microprocessor, microcontroller, ASIC, a programmable gate array (PGA), and the like. As used herein, the term “computer system” may refer to any type of processor-based system, such as a desktop computer, a server computer, a laptop computer, an appliance or set-top box, or the like.

Processor 410 may be coupled over host bus 415 to memory hub 420 in one embodiment, which may be coupled to system memory 430 via memory bus 425. Memory hub 420 may also be coupled over Advanced Graphics Port (AGP) bus 433 to video controller 435, which may be coupled to display 437. AGP bus 433 may conform to the Accelerated Graphics Port Interface Specification, Revision 2.0, published May 4, 1998, by Intel Corporation, Santa Clara, Calif.

Memory hub 420 may also be coupled (via hub link 438) to input/output (I/O) hub 440 that is coupled to input/output (I/O) expansion bus 442 and Peripheral Component Interconnect (PCI) bus 444, as defined by the PCI Local Bus Specification, Production Version, Revision 2.1, dated in June 1995. I/O expansion bus 442 may be coupled to I/O controller 446 that controls access to one or more I/O devices. As shown in FIG. 5, these devices may include in one embodiment I/O devices, such as keyboard 452 and mouse 454. I/O hub 440 may also be coupled to, for example, hard disk drive 456 and compact disc (CD) drive 458, as shown in FIG. 5. It is to be understood that other storage media may also be included in the system.

In an alternative embodiment, I/O controller 446 may be integrated into I/O hub 440, as may other control functions. PCI bus 444 may also be coupled to various components including, for example, a stereo digital video input or video capture device 462 and stereo video camera 463, in an embodiment in which image pairs are obtained by a stereo camera. Additionally, network controller 460 may be coupled to a network port (not shown).

Additional devices may be coupled to I/O expansion bus 442 and PCI bus 444, such as an input/output control circuit coupled to a parallel port, serial port, a non-volatile memory, and the like.

Although the description makes reference to specific components of system 400, it is contemplated that numerous modifications and variations of the described and illustrated embodiments may be possible. For example, instead of memory and I/O hubs, a host bridge controller and system bridge controller may provide equivalent functions. In addition, any of a number of bus protocols may be implemented.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
grouping pixels of columns of a first image of an image pair into column segments; and
creating a disparity map for the image pair using the column segments.

2. The method of claim 1, further comprising grouping the pixels based on an intensity gradient of the pixels.

3. The method of claim 1, wherein grouping the pixels comprises performing a linear approximation of intensity of the columns.

4. The method of claim 3, wherein performing the linear approximation comprises allowing a user to select a desired approximation.

5. The method of claim 1, wherein creating the disparity map comprises estimating a disparity for all rows of the image pair simultaneously.

6. The method of claim 1, further comprising automatically determining an occlusion cost.

7. The method of claim 6, wherein automatically determining the occlusion cost comprises selecting a minimum value of a sum of disparity dispersions for the column segments.

8. The method of claim 1, wherein creating the disparity map further comprises calculating a single intensity difference between the image pair for each of the column segments.

9. A method comprising:
obtaining a first image and a second image of an image pair; and
simultaneously processing all image rows of the image pair to determine a disparity map for the image pair.

10. The method of claim 9, further comprising segmenting columns of at least one of the first image and the second image into a plurality of segments.

11. The method of claim 10, wherein segmenting the columns comprises performing a linear approximation of intensity of the columns.

12. The method of claim 11, further comprising automatically determining an occlusion cost.

13. The method of claim 12, wherein automatically determining the occlusion cost comprises selecting a minimum value of a sum of disparity dispersions for the plurality of segments.

14. The method of claim 10, wherein simultaneously processing the image rows comprises calculating a single intensity difference between the image pair for each of the plurality of segments.

15. The method of claim 10, wherein simultaneously processing the image rows comprises selecting an optimal pass for the image rows based on connections between the plurality of segments of an adjoining pair of the columns.

16. An article comprising a machine-readable storage medium containing instructions that if executed enable a system to:
group pixels of columns of a first image of an image pair into column segments, and
create a disparity map for the image pair using the column segments.

17. The article of claim 16, further comprising instructions that if executed enable the system to group the pixels based on an intensity gradient of the pixels.

18. The article of claim 16, further comprising instructions that if executed enable the system to automatically determine an occlusion cost.

19. The article of claim 16, further comprising instructions that if executed enable the system to calculate a single intensity difference between the image pair for each of the column segments.

20. An apparatus comprising:
at least one storage device containing instructions that if executed enable the apparatus to group pixels of columns of a first image of an image pair into column segments and to create a disparity map for the image pair using the column segments; and
a processor coupled to the at least one storage device to execute the instructions.

21. The apparatus of claim 20, further comprising at least one video capture device coupled to the processor to provide information regarding the image pair.

22. The apparatus of claim 20, further comprising instructions that if executed enable the apparatus to group the pixels based on an intensity gradient of the pixels.

23. The apparatus of claim 20, further comprising instructions that if executed enable the apparatus to estimate a disparity for all rows of the image pair simultaneously.

24. A system comprising:
a dynamic random access memory containing instructions that if executed enable the system to group pixels of columns of a first image of an image pair into column segments and to create a disparity map for the image pair using the column segments; and
a processor coupled to the dynamic random access memory to execute the instructions.

25. The system of claim 24, further comprising at least one video capture device coupled to the processor to provide information regarding the image pair.

26. The system of claim 24, further comprising instructions that if executed enable the system to group the pixels based on an intensity gradient of the pixels.
